(19) United States
(12) Patent Application Publication
(10) Pub. No.: US 2006/0276186 A1
(43) Pub. Date: Dec. 7, 2006

(54) Electronic key apparatus for vehicle

(75) Inventors: Yukihiro Hamamura, Hyogo (JP); Akihiko Mori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/258,036

(22) Filed: Oct. 26, 2005

(30) Foreign Application Priority Data
Jun. 6, 2005 (JP) P2005-165835

(51) Int. Cl. H04M 3/00

(52) U.S. Cl. 455/420

(57) ABSTRACT

An electronic key apparatus for vehicle includes a vehicle mounted device, and a portable device. When the vehicle mounted device communicates with the portable device and verifies an ID code for the portable device, the vehicle mounted device activates a control device mounted on the vehicle. The vehicle mounted device includes a first transmission/reception unit, a first memory that stores ID codes, a first CPU that transmits a request signal to the portable device, and decrypts whether a received answering signal matches the ID code, and a drive unit that outputs a control signal. The portable device includes a second transmission/reception unit, a second memory that stores an inherent ID code, and a second CPU that receives the request signal, encrypts the inherent ID code and transmits as an answering signal. The vehicle mounted device further includes an order changing unit that changes an order of transmitting request signals.

### BACKGROUND OF THE INVENTION

1. Field of the Invention

The present invention relates to the improvement of an electronic key apparatus for vehicle that compares ID code through communication between portable devices for a vehicle and a vehicle mounted device, and locks or unlocks the doors, the steering wheel, the gearbox and the trunk of a vehicle or starts the engine.

2. Description of the Related Art

Conventionally, an electronic key apparatus is available with which, to lock or unlock the doors of a vehicle or to start the engine of the vehicle, a user inserts a key into a keyhole and turns the key, and another electronic apparatus is available according to which, much like a card key, a key (a portable device) is kept in the pocket or bag of a user of a vehicle, and without the key being touched, wireless communication is established between it and a vehicle mounted device in the vehicle that receives, from the portable device, an ID code that the vehicle mounted device compares with code that is stored in memory. Then, if the codes match, the vehicle mounted device unlocks or locks the doors of the vehicle.

For these electronic key apparatuses, the IDs of the portable devices must be registered in advance with the vehicle mounted devices. To effect this registration, a registration mode is set using a conventional switch in a prescribed order, and a code transmitted by the portable device is received and registered by the vehicle mounted device.

According to Japanese Patent No. 3,589,188, a vehicle mounted device communicates by wireless with a portable device to avoid to leave the portable device in the vehicle, and when there is no reply from the portable device, assumes that the portable device is not present in the vehicle. And according to Japanese Patent No. 3,191,607, when a portable device is lost, and the registration of a new code for the portable device is required, a simple registration method is provided. However, since use of a plurality of portable devices is permitted, the vehicle mounted device does not know which portable device the user is currently employing, and must transmit a request signal to all the portable devices that have been registered. Further, since a user, when starting the engine of a vehicle, often manipulates the ignition switch rapidly, communication and verification between the vehicle mounted device and the portable device can not keep up, so that the starting of the engine is delayed, or can not be executed.

### SUMMARY OF THE INVENTION

According to an aspect of the present invention, an electronic key apparatus for vehicle includes a vehicle mounted device mounted on a vehicle, and a portable device possessed by a user. When the vehicle mounted device communicates with the portable device and verifies an ID code for the portable device, the vehicle mounted device activates a control device mounted on the vehicle. The vehicle mounted device includes a first transmission/reception unit that communicates with the portable device, a first memory that stores a plurality of ID codes used to authenticate a plurality of portable devices, a first CPU that transmits a request signal via the first transmission/reception unit to request the portable device to furnish an ID code, that receives an answering signal from the portable device, and that decrypts whether a content of the answering signal matches the ID code stored in the first memory, and a drive unit that when the content matches the ID code outputs a control signal to the control devices. The portable device includes a second transmission/reception unit that communicates with the vehicle mounted device, a second memory that stores an ID code inherent to the portable device, and a second CPU that receives the request signal transmitted from the vehicle mounted device via the second transmission/reception unit, and that when a content of the request signal is inherent to the portable device encrypts the ID code stored in the second memory and transmits the encrypted ID code as an answering signal. The vehicle mounted device further includes an order changing unit that in accordance with a reception of the ID code from the portable device changes an order of transmitting request signals from the vehicle mounted device.

Further, according to the electronic key apparatus for vehicle of this invention, the vehicle mounted device also includes a collective call code calculation unit that simultaneously transmits a request signal to all the portable devices for which ID codes are stored in the first memory. When the second CPU of each of the portable devices acknowledges the reception of a collective call code, the second CPU transmits an answering signal inherent to the portable device.

According to this invention, communication with the portable devices can be initiated and performed in order, beginning with the portable device for which the usage frequency is the highest. Or, a collective call can be enabled for all available portable devices. As a result, reductions can be achieved both in the power and in the time required for communication and verification.

### BRIEF DESCRIPTION OF THE DRAWINGS

FIG. 1 is a diagram showing the general configuration of the present invention;

FIG. 2 is a time chart showing a first embodiment of the present invention;

FIG. 3 is a flowchart showing the first embodiment of the present invention;

FIG. 4 is a flowchart showing the second embodiment of the present invention; and

FIG. 5 is a flowchart showing the third embodiment of the present invention.

### DETAILED DESCRIPTION OF THE INVENTION

### First Embodiment

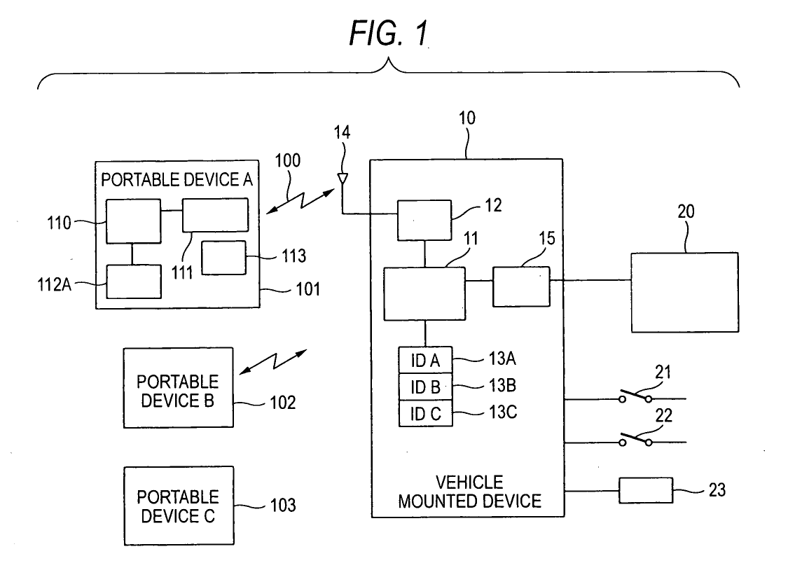

A first embodiment of the present invention will now be described. FIG. 1 is a conceptual diagram showing an electronic key apparatus for vehicle according to this embodiment. A vehicle mounted device 10 is arranged at a predetermined location in a vehicle, and A, B and C are portable devices 101, 102 and 103. The vehicle mounted device 10 includes a first CPU 11, a first transmission/reception unit 12, a first memory 13, an antenna 14 and a drive unit 15. A vehicle control device 20 is, for example, a door locking or unlocking device or an engine ignition device. Switches 21 and 22 and a display unit 23 are also provided. As the basic operation of the vehicle mounted device 10, when a user manipulates the switch 21, the vehicle mounted device 10 detects this manipulation and is activated, and the first CPU 11 permits the first transmission/reception unit 12 to transmit a request signal 100 to the portable devices 101, 102 and 103. Upon receiving this request signal 100, the portable device 101, 102 or 103 transmits an answering signal 100, and the vehicle mounted device 10 receives this signal via the antenna 14 and the first transmission/reception unit 12. The first CPU 11 decrypts the received contents, and reads IDA (13A), IDB (13B) and IBC (13C), stored in the first memory 13, and compares them with the received contents. When one of the IDs stored in the memory matches the received contents, the first CPU completes a so-called authentication process, and outputs a control signal via the drive unit 15. Thus, the control device 20 permits, for example, the locking or unlocking of the doors of the vehicle, or the starting of the engine.

Since the same configuration is employed for the portable devices 101, 102 and 103, only the portable device 101 will be described. The portable device 101 includes a second CPU 110, a second transmission/reception unit 111, a second memory 112 and a battery 113. In the second memory 112, an ID is registered for each of the portable device 101. As the basic operation of the portable device 101, the second transmission/reception unit 111 receives a request signal from the vehicle mounted device 10, and based on the contents of the request signal, the second CPU 110 first determines whether the request has been issued to the portable device 110. Since an identification code for each portable device is included in the request signal, the second CPU 110 does not issue an answering signal when the request signal is not pertinent to the portable device 101. When the request signal is pertinent to the portable device 101 (portable device A), the second CPU 110 reads the ID code from the second memory 112A, encrypts the ID code and transmits the encrypted ID code to the second transmission/reception unit 111.

At this time, since the vehicle mounted device 10 does not know which portable device the user is currently employing, the vehicle mounted device 10 transmits, as request signals, the codes of all the portable devices stored in the memory. However, when a request signal is transmitted to unused portable devices, time and power are wasted, as is the time it takes for communication and authentication. Thus, when the vehicle mounted device 10 transmits request signals in the order in which portable devices are employed by the user, power and communication time can be saved.

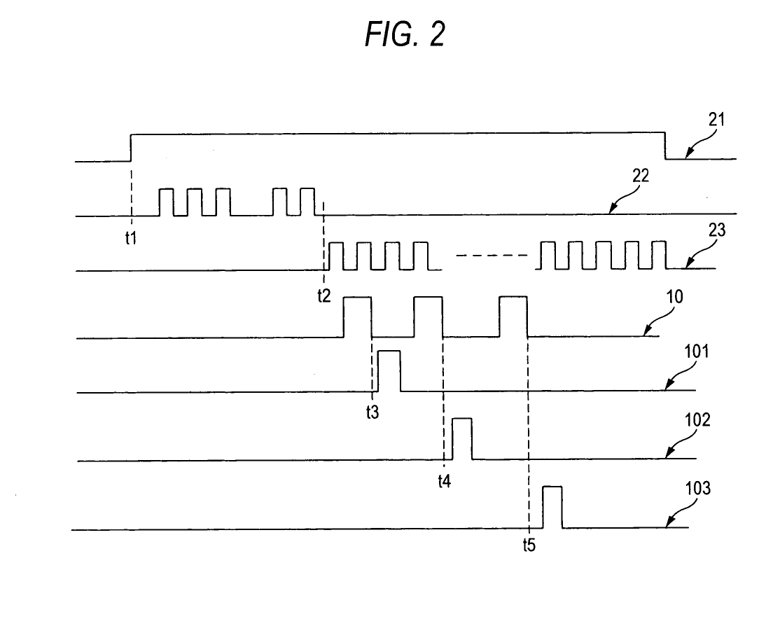

First, the processing for registering the portable devices will be described while referring to FIG. 2. In FIG. 2, a method for registering the ID codes of portable devices is shown along the time axis. First, for example, the ignition switch 21 arranged in a vehicle is turned on (t1). Then, the other switch 22 is turned on and off, as designated in advance, within a predetermined period of time. Referring to FIG. 2, the switch 22 is turned on and off three times, and thereafter, on and off twice (t2). Then, the ID code registration enabling mode is entered, and the user, by viewing the display unit 23, can identify the effect this produces. Thereafter, when the vehicle mounted device 10 detects that the user has employed the switches 21 and 22 to perform a predetermined manipulation, a prearranged series of blinks is displayed on the display unit 23 to indicate the on and off states.

Next, the vehicle mounted device 10 transmits a registration request signal to the portable device 101, 102 or 103 to be registered. So long as the user carries the portable device 101, 102 or 103, the portable device 101, for example, responds to the first transmission (t3) by the vehicle mounted device 10 and transmits encrypted information as an answering signal that includes ID code to be registered. The vehicle mounted device 10 receives the answer signal via the antenna 14 and the first transmission/reception unit 12, and the first CPU 11 decrypts the signal, converts the decrypted signal into a form to be registered, and stores the resultant signal in the first memory 13A. Thereafter, employing the same processing, the CPU 11 transmits a registration request signal (t5), receives ID code from the portable device 102 and stores the ID code in the first memory 13B. Then, the same processing is again employed and the ID code of the third portable device 103 is stored in the first memory 13C. Finally, the switch 21 is turned off to terminate the registration mode.

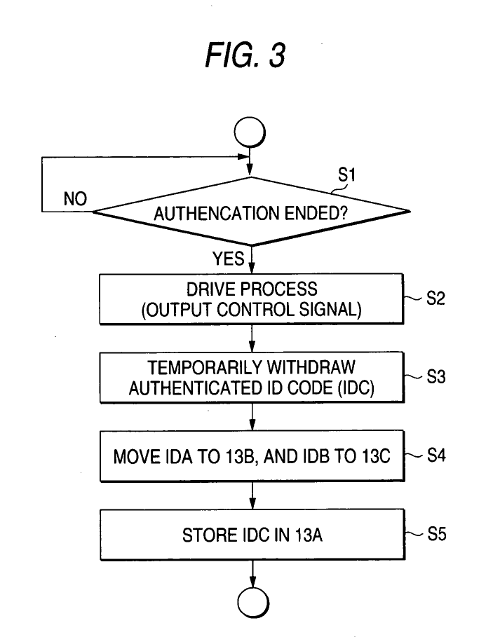

While referring to FIG. 3, an explanation will now be given for an example wherein, of the registered portable devices, the user mainly employs the portable device 103. Assume that the vehicle mounted device 10 performs an access in the order of use of the first memories 13A, 13B and 13C in FIG. 1. When the user, while carrying the portable device 103, locks the doors of the vehicle or starts the engine, the first CPU 11 communicates with the portable device 103, and when the authentication process is completed, rearranges the contents of the first memory. At step S1, a check is performed to determine whether the authentication process has been completed. When the authentication has been completed (YES), it is assumed that the portable device 103 is normally employed. And when the authentication process has not been completed (NO), the following routine is not performed. When the authentication process has been completed (YES), at step S2, as a result of the authentication process, a control signal is output to a drive unit (15 in FIG. 1). Thus, permission is issued for the locking or the unlocking of the doors, or for starting the engine. Then, at step S3, the authenticated ID code (IDC) is temporarily withdrawn.

At step S4, ID codes (IDA and IDB) that were not used are moved to the first memories 13B and 13C, and at step S5, the IDC temporarily withdrawn is moved to and stored in the first memory 13A. The rearrangement process is then terminated. Through this process, since the transmission order is changed each time the ID code of the portable device is used and authenticated and the first ID code of the previously used portable devices is transmitted by the vehicle mounted device 10, a reduction in the communication and authentication times and saving in the transmission power can be realized.

Further, since the first memory is saved after the use of the vehicle has ended, when the user employs the same portable device the next time, it is ensured that the previously employed portable device 103 will come first in the transmission order. As a result, the communication is quickly performed, and this is very convenient. In this embodiment, the transmission order has been changed by using the first memory; however, the same effect can be obtained by employing for a transmission order a third, special memory. With this arrangement, the number of times required to access an important memory that is used for registration and authentication can be reduced, and accordingly, the probability that the contents of the memory will be altered, due to noise, will be reduced. Also, in this embodiment, ID code transmission has been explained; however, so-called wake-up code transmission can be employed. Generally, according to the wake-up code transmission, the second CPU 110 of the portable device can be awakened by calling the portable device (a wake-up call), and the ID code is transmitted as a request signal. For such a transmission, as well as for the ID code transmission, the order in which the wake-up code is transmitted can be changed each time the wake-up code is used.

### Second Embodiment

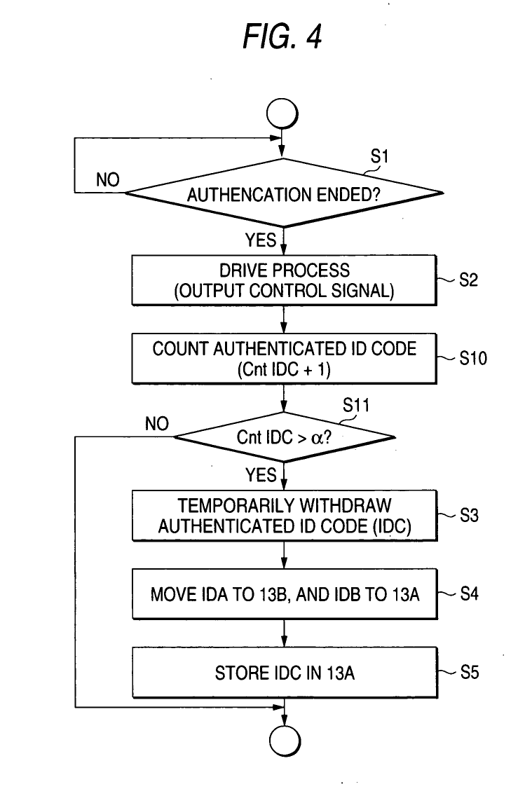

A second embodiment of the present invention will now be described. For the first embodiment, since the order in which the portable devices are used is rearranged each time an authentication process is performed, the order of use is changed even when the user temporarily uses a spare key. According to the second embodiment, a method for rearranging the order of use in accordance with the use frequency will now be described while referring to FIG. 4. The same step numbers as are used in FIG. 3 are employed for corresponding or identical processes.

After the processes at steps S1 and S2 have been completed, at step S10, a counter value CntIDC, which corresponds to the ID code used for authentication, is incremented by one. Although not shown, this counter value is held for each ID code. At step S11, a check is performed to determine whether the counter value CntIDC is greater than a predetermined value α. When the counter value is smaller than the predetermined value (NO), all the processing is terminated. When the counter value is greater than the predetermined value (YES), the processes at steps S3, S4 and S5 are performed. The counter value may be reset either after the processes at steps S3, S4 and S5 have been completed or after the device has been powered on.

Through this processing, when the number of times used is smaller than a predetermined value, the conventional transmission order is maintained to prevent the temporarily used portable device from becoming the first in the transmission order. As a result, the ID code of the portable device having the highest use frequency is ranked first in the transmission order. Also in this case, a third, special memory may be employed for the transmission order.

### Third Embodiment

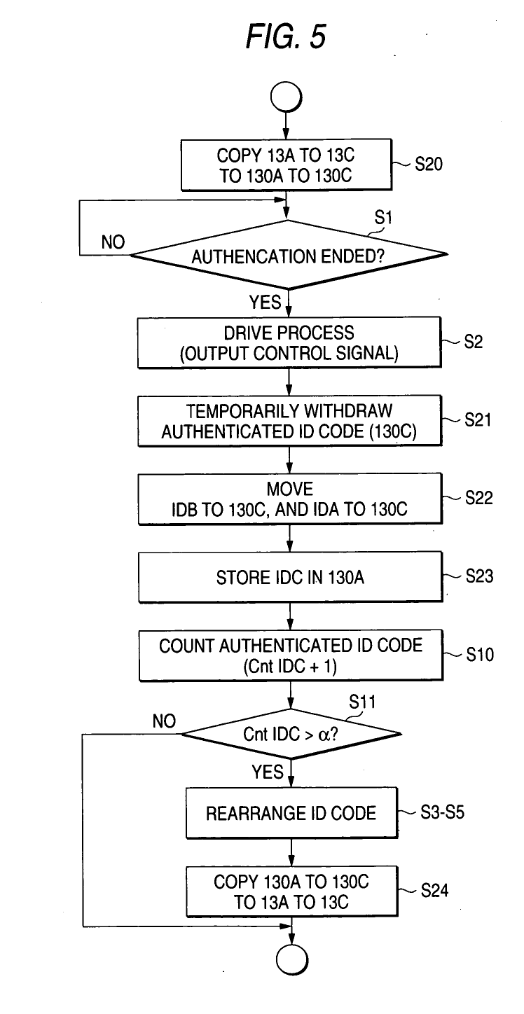

A third embodiment of the present invention will now be described. According to the second embodiment, the transmission order cannot be changed unless a specific portable device is used a predetermined number of times, at the least, and for the portable device, a low transmission order is maintained so long as it is used only a few times. The processing for taking a countermeasure will now be described while referring to FIG. 5. The same step numbers as are used in FIGS. 3 and 4 are employed for corresponding processes.

Assume that the vehicle mounted device 10 includes use order memories 130A, 130B and 130C, as well as the first memories 13A, 13B and 13C in FIG. 1. When the vehicle mounted device 10 is first powered on, at step S20, the contents of the first memories 13A, 13B and 13C are copied to the use order memories 130A, 130B and 130C. As a result, the use order is determined. After the processes at steps S1 and S2 are completed, at step S21, the ID code (IDC) for the use order memory 130C is temporarily withdrawn, and at step S22, the contents of the use order memory 130B are moved to the use order memory 130C, while the contents of the use order memory 130A are moved to the use order memory 130B. At step S23, the IDC temporarily withdrawn is moved to and stored in the use order memory 130A. Thus, the use order is changed each time authentication is performed.

After the processes at steps S10 and 11 have been performed, at step S24, the order in the first memory is changed in accordance with the use order memories. The values held by counters and the resetting of the counter values are the same as those in the second embodiment. By performing the above individual processes, the portable device currently employed is ranked first in the order of transmission by the vehicle mounted device 10. When this portable device is used frequently, only the transmission order in the first memory need be changed to alter this ranking. Then, when after having been turned off, the power is again turned on, the use ranking is maintained. As a result, the use ranking for the portable device currently being employed can be determined and the ranking can be established for the portable device having the highest use frequency. Therefore, a condition that is more convenient for a user is provided.

### Fourth Embodiment

A fourth embodiment of the present invention will now be described. First, the first CPU 11 of the vehicle mounted device 10 calculates an ID code to be used in common for the individual ID codes that are stored in the first memories 13A, 13B and 13C. As one calculation method, assume, for example, that calling numbers inherent to the portable devices 101, 102 and 103 in FIG. 1 are XXXX101, XXXX102 and XXXX103, wherein, for example, XXXX are numbers for identifying makers, model types or years of vehicles. In this case, the first CPU 11 obtains XXXX10* as a common ID code. “*” is a wild card used in computer language, and represents a number of from 0 to 9. Therefore, the first CPU 11, for example, adds a “z”, corresponding to “*”, and transmits “XXXX10z” as the transmission code. This transmission code is used to represent a collective call code.

The portable device 101, 102 or 103 is so programmed that the second CPU 110, upon receiving “XXXX10z”, handles the code in the same manner as the normal code. That is, the second CPU 110 retrieves the inherent ID code from the second memory 112, encrypts the ID code, and transmits an answering signal via the second transmission/reception unit 111. In other words, the portable device is programmed to transmit the same answering signal upon the reception of a collective call code and an individual call code. Further, in order to avoid interference, the timing for the transmission of the answering signals is varied slightly among the individual portable devices.

Because only one collective call code is transmitted, the vehicle mounted device 10 can expect to receive a reply, and the required communication and authentication times can be reduced. Furthermore, another effect is that saving in transmission power will be realized. In addition, the wake-up code can be employed instead of the ID code.

This invention can be applied not only for electronic key apparatuses for vehicles, but also, for example, for electronic key apparatuses of the same kind for motorcycles, ships, airplanes, etc.

What is claimed is:

1. An electronic key apparatus for vehicle comprising:
a vehicle mounted device mounted on a vehicle; and
a portable device possessed by a user,
wherein when the vehicle mounted device communicates with the portable device and verifies an ID code for the portable device, the vehicle mounted device activates a control device mounted on the vehicle,
the vehicle mounted device includes:
a first transmission/reception unit that communicates with the portable device;
a first memory that stores a plurality of ID codes used to authenticate a plurality of portable devices;
a first CPU that transmits a request signal via the first transmission/reception unit to request the portable device to furnish an ID code, that receives an answering signal from the portable device, and that decrypts whether a content of the answering signal matches the ID code stored in the first memory; and
a drive unit that when the content matches the ID code outputs a control signal to the control devices,
the portable device includes:
a second transmission/reception unit that communicates with the vehicle mounted device;
a second memory that stores an ID code inherent to the portable device; and
a second CPU that receives the request signal transmitted from the vehicle mounted device via the second transmission/reception unit, and that when a content of the request signal is inherent to the portable device encrypts the ID code stored in the second memory and transmits the encrypted ID code as an answering signal, and
the vehicle mounted device further includes:
an order changing unit that in accordance with a reception of the ID code from the portable device changes an order of transmitting request signals from the vehicle mounted device.

2. The electronic key apparatus for vehicle according to claim 1,
wherein the vehicle mounted device transmits the request signal in accordance with an order of ID codes stored in a memory of the vehicle mounted device, and
when ID code verification is completed through a communication between the vehicle mounted device and the portable device, the order changing unit changes the order of the ID codes stored in the memory.

3. The electronic key apparatus for vehicle according to claim 1,
wherein the vehicle mounted device transmits the request signal in accordance with an order of the ID codes stored in the first memory of the vehicle mounted device, and
when verification of the ID codes stored in the first memory is completed, through a communication between the vehicle mounted device and the portable device, the order changing unit changes the order of the ID codes stored in the first memory.

4. The electronic key apparatus for vehicle according to claim 1,
wherein when a frequency at which the vehicle mounted device completes verification of the portable device is equal to or greater than a predetermined value, the order changing unit of the vehicle mounted device changes an order of the ID codes stored in the first memory.

5. An electronic key apparatus for vehicle comprising:
a vehicle mounted device mounted on a vehicle; and
a portable device possessed by a user,
wherein when the vehicle mounted device communicates with the portable device and verifies an ID code for the portable device, the vehicle mounted device activates a control device mounted on the vehicle,
the vehicle mounted device includes:
a first transmission/reception unit that communicates with the portable device;
a first memory that stores a plurality of ID codes used to authenticate a plurality of portable devices;
a first CPU that transmits a request signal via the first transmission/reception unit to request the portable device to furnish an ID code, that receives an answering signal from the portable device, and that decrypts whether a content of the answering signal matches the ID code stored in the first memory; and
a drive unit that when the content matches the ID code outputs a control signal to the control devices,
the portable device includes:
a second transmission/reception unit that communicates with the vehicle mounted device;
a second memory that stores an ID code inherent to the portable device; and
a second CPU that receives the request signal transmitted from the vehicle mounted device via the second transmission/reception unit, and that when a content of the request signal is inherent to the portable device encrypts the ID code stored in the second memory and transmits the encrypted ID code as an answering signal inherent to the portable device, the vehicle mounted device further includes:
a collective call code calculation unit that transmits the request signal to all the portable devices for which ID codes are stored in the first memory by a single transmission, and
when the second CPU of each of the portable devices acknowledges a reception of a collective call code, the second CPU transmits the answering signal inherent to the portable device.
